(19) United States
(12) Patent Application Publication
(10) Pub. No.: US 2008/0288403 A1
(43) Pub. Date: Nov. 20, 2008

(54) PIN ENCRYPTION DEVICE SECURITY

(76) Inventor: Clay von Mueller, San Diego, CA (US)

Correspondence Address: SHEPPARD, MULLIN, RICHTER & HAMPTON LLP, 333 SOUTH HOPE STREET, 48TH FLOOR, LOS ANGELES, CA, 90071-1448, US

(21) Appl. No.: 11/750,511

(22) Filed: May 18, 2007

(51) Int. Cl. G06Q 40/00

(52) U.S. Cl. 705/44

(57) ABSTRACT

An apparatus and method for securing transaction data, includes reading token data from a token using a read apparatus and encrypting the token data at the read apparatus, sending the encrypted token data to a security module over a communication link, and verifying the integrity of the communication link based on encrypted token data. The apparatus and method can further include receiving authentication data for the token and encrypting the authentication data within the security module, and combining the encrypted token data and encrypted authentication data into a transaction data stream. In various embodiments, a detection apparatus with plurality of read structures (for example, read gaps), can be used to provide additional information in verifying the integrity of the communication link comprises determining whether the read structures are detecting token data with a spatially diversity in accordance with a geometry of the read structures.

### TECHNICAL FIELD

The present invention relates to secure transactions, and more particularly, some embodiments relate to secure PIN Pad transactions.

### DESCRIPTION OF THE RELATED ART

Token systems have been in use in modern civilization in various implementations to provide and control many forms of access. Access that can be and often times is controlled by tokens can include physical access to rooms, buildings, areas and so on; electronic access to servers and datafiles; electronic account access; and so on. Another form of access controlled by tokens is the ability to conduct transactions such as, for example, credit, debit and other financial transactions. Credit cards, charge cards, debit cards, loyalty cards and other purchase-related tokens often are used to provide the consumers with ready access to funds. Such transactions can enhance convenience of purchases, extend credit to customers, and so on.

Certain tokens, such as debit cards and others, for example, require the user to enter a PIN (personal identification number) or other verification code to authenticate the user or otherwise help to verify that the user is, in fact, an authorized user of the card. Such verification can be used at access points such as, for example, point-of sale terminals or ATM machines. At such locations, the user swipes his or her card through a card reader or inserts it into chip reader. For purchases at a point-of-sale terminal, the merchant usually enters the amount of the transaction and the customer enters their PIN for authorization.

At retail outlets it is commonplace to have a terminal that can read a swiped or inserted card and that also includes a keypad for PIN entry. Such terminals are sometimes referred to as PIN pad devices or Pin Entry Devices (PEDs), and such terminals can include an integrated card reader. With increases in identity theft and other related crimes, industry trends have been to encrypt the PIN information as well as token data. For example, PEDs are available that use Hardware Security Modules, or HSMs, to encrypt and secure the entered PIN data. In such PEDs, the encryption keys and encryption engine are encased in the hardware security module. The hardware security module protects the sensitive encryption information from tampering and theft. Particularly, the hardware security module is configured such that if it is opened, the encryption keys are destroyed such that they cannot be stolen or copied. By blocking access to the encryption keys, a would be identity thief is prevented from decrypting encrypted PIN information.

However, one challenge facing such pin entry devices is the fact that the link between the token read apparatus (i.e., the read head for magnetic stripe tokens) and the hardware secure module carries clear text token information such as, for example, account information. clear text information between the read apparatus and the hardware security module is not secured and can be tapped or tampered with. expanding the security perimeter of the hardware security module to encompass the entire PED is one solution. However, such a solution would not be a cost-effective manner of securing the PED as a larger perimeter hardware security module would lead to higher costs. furthermore, expanding the hardware security module perimeter to cover the entire terminal, or PED, would inhibit the ability to service otherwise serviceable areas of the PED.

### BRIEF SUMMARY OF EMBODIMENTS OF THE INVENTION

According to various embodiments of the invention systems and methods for secure transactions are provided. In accordance with one embodiment of the invention, a method for securing transaction data includes reading token data from a token using a read apparatus and encrypting the token data at the read apparatus; sending the encrypted token data to a security module over a communication link; and verifying the integrity of the communication link based on encrypted token data. In one embodiment, the method can further include the steps of receiving authentication data for the token and encrypting the authentication data within the security module and combining the encrypted token data and encrypted authentication data into a transaction data stream.

In accordance with one embodiment, the step of reading token data includes the step of detecting token data at a plurality of read structures, and the step of verifying the integrity of the communication link includes determining whether the read structures are detecting token data with a spatially diversity in accordance with a geometry of the read structures. In accordance with yet another embodiment of the invention, the step of reading token data includes the step of detecting token data at a plurality of read structures, and the step of verifying the integrity of the communication link includes detecting distances between transitions based on distances between the read structures. In a further embodiment, the step of reading token data includes the step of detecting token data at a plurality of read structures, and the step of verifying the integrity of the communication link includes determining whether the first gap detects data different from that detected by the second gap at a given read time.

In accordance with another embodiment, the step of reading token data includes the step of detecting token data at a plurality of read structures, and the step of verifying the integrity of the communication link includes determining whether, over a predetermined time period, the first and second gaps are sensing the same transitions at substantially the same time to verify the integrity of the link. In another embodiment, the method further includes the step of generating an alert if the integrity of the link is determined to be compromised.

In another embodiment, a transaction terminal is provided that includes a token data encryption module configured to encrypt data read from a token at the terminal; a communication link coupled to the encryption module; and a verification module coupled to the communication link and configured to verify the integrity of the communication link. In a further embodiment, the transaction terminal further includes

a user interface configured to accept authentication data for the token and an authentication data encryption module coupled to the interface; and a data packaging module coupled to the authentication data encryption module and to the communication link and configured to package the encrypted authentication data and the encrypted token data into transaction data. The transaction terminal can also be configured to include a secure module enclosing the authentication encryption module.

In one embodiment, the data capture device is a multi-gap magnetic read head. In another embodiment, the data capture device includes multiple read structures. In yet another embodiment, the verification module is further configured to determine whether the read structures are detecting token data with a spatially diversity in accordance with a geometry of the read structures. The verification module can also be further configured to detect distances between transitions based on distances between the read structures. The verification module can also be further configured to determine whether the first gap detects data different from that detected by the second gap at a given read time. In another embodiment, The verification module can also be configured to determine whether, over a predetermined time period, the first and second gaps sense the same transitions at substantially the same time to verify the integrity of the link.

In still another embodiment of the invention, a computer program product having a computer program embodied in a computer readable medium adapted to verify the integrity of token data read at a transaction terminal can be provided. The computer program in one embodiment includes machine readable code adapted to cause a processing device to: read token data from a token using a read apparatus and encrypting the token data at the read apparatus; send the encrypted token data to a security module over a communication link; and verify the integrity of the communication link based on encrypted token data. In one embodiment, the computer program product further includes machine readable code adapted to cause a processing device to: receive authentication data for the token and encrypting the authentication data within the security module; and combine the encrypted token data and encrypted authentication data into a transaction data stream. In yet another embodiment the machine readable code adapted to cause a processing device to read token data includes machine readable code adapted to cause a processing device to detect token data at a plurality of read structures, and the machine readable code adapted to cause a processing device to verify the integrity of the communication link includes machine readable code adapted to cause a processing device to determine whether the read structures are detecting token data with a spatially diversity in accordance with a geometry of the read structures.

In a further embodiment, the machine readable code adapted to cause a processing device to read token data includes machine readable code adapted to cause a processing device to detect token data at a plurality of read structures, and the machine readable code adapted to cause a processing device to verify the integrity of the communication link includes machine readable code adapted to cause a processing device to detect distances between transitions based on distances between the read structures.

In still another embodiment, the machine readable code adapted to cause a processing device to read token data includes machine readable code adapted to cause a processing device to detect token data at a plurality of read structures, and the machine readable code adapted to cause a processing device to verify the integrity of the communication link includes machine readable code adapted to cause a processing device to determine whether the first gap detects data different from that detected by the second gap at a given read time.

In yet another embodiment, the machine readable code adapted to cause a processing device to read token data includes machine readable code adapted to cause a processing device to detect token data at a plurality of read structures, and the machine readable code adapted to cause a processing device to verify the integrity of the communication link includes machine readable code adapted to cause a processing device to determine whether, over a predetermined time period, the first and second gaps are sensing the same transitions at substantially the same time to verify the integrity of the link. In a further embodiment, the machine readable code further includes machine readable code adapted to cause a processing device to generate an alert if the integrity of the link is determined to be compromised.

Other features and aspects of the invention will become apparent from the following detailed description, taken in conjunction with the accompanying drawings, which illustrate, by way of example, the features in accordance with embodiments of the invention. The summary is not intended to limit the scope of the invention, which is defined solely by the claims attached hereto.

### BRIEF DESCRIPTION OF THE DRAWINGS

The present invention, in accordance with one or more various embodiments, is described in detail with reference to the following figures. The drawings are provided for purposes of illustration only and merely depict typical or example embodiments of the invention. These drawings are provided to facilitate the reader's understanding of the invention and shall not be considered limiting of the breadth, scope, or applicability of the invention. It should be noted that for clarity and ease of illustration these drawings are not necessarily made to scale.

FIG. 1 is a diagram illustrating one example of a transaction network with which the present invention can be implemented.

FIG. 2 is a diagram illustrating an implementation of features that can be associated with the invention in accordance with one embodiment of the invention.

FIG. 3 is an operational flow diagram illustrating a process for enabling secure token transactions in accordance with one embodiment of the invention.

FIG. 4 is a functional block diagram illustrating an example PIN encryption device terminal in accordance with one embodiment of the invention.

FIG. 5 is a diagram illustrating an example vulnerability of a communication link.

The figures are not intended to be exhaustive or to limit the invention to the precise form disclosed. It should be understood that the invention can be practiced with modification and alteration, and that the invention be limited only by the claims and the equivalents thereof.

### DETAILED DESCRIPTION OF THE EMBODIMENTS OF THE INVENTION

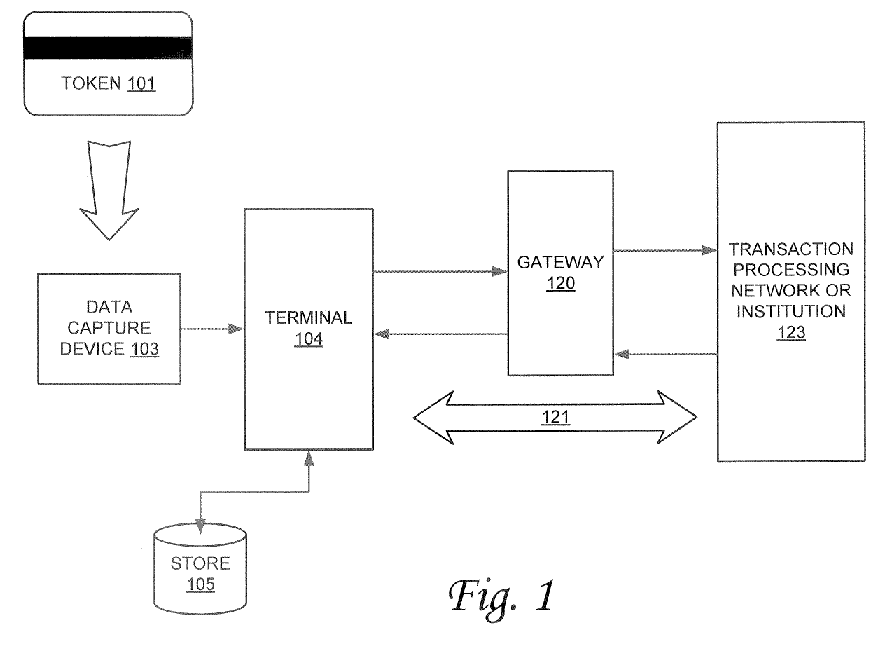

Before describing the invention in detail, it is useful to describe an example environment with which the invention can be implemented. One such example is that of a transaction card network including a token used to facilitate purchases or other transactions. FIG. 1 is a diagram illustrating one example of a transaction network with which the present invention can be implemented. Referring now to FIG. 1, an example of transaction network is a token network that can be used to authorize and settle purchases of various goods and services. Illustrative examples of implementations of such a transaction network are the charge card, credit card and debit card transaction networks used to facilitate purchase transactions and banking transactions by and among merchants and other businesses, banks and other financial institutions and individuals. Generally speaking, in such a transaction network, the customer utilizes a charge card, credit card, debit card or other token as a symbol of his or her identity, or as an identification of the account he or she would like to have charged for the transaction. The token is typically accepted by the merchant, the account information read, and used to credit the transaction. Merchants may ask for a driver's license or other form of identification to verify the identity of the purchaser in conjunction with the token issued.

The token data is then sent to the appropriate financial institution or institutions, or other entities for processing. Processing can include, in one or more steps, authorization, approval and settlement of the account. As the example in FIG. 1 illustrates, a token 101 can be used by the customer to facilitate the transaction. As stated, in this example environment, examples of token 101 can include a charge card, debit card, credit card, royalty card, or other token that can be used to identify such items as the customers, their account, and other relevant information. As a further example, a card such as a credit or debit card can include various forms of technology to store data, such as a magnetic stripe technology, processor or smart card technology, bar code technology or other technology used to encode account number or other identification or information onto the token. As such, a properly encoded token can include various forms of information relating to the purchaser such as, for example, the identity of the purchaser, information associated with the purchaser's account, the issuing bank or other financial institution, the expiration date, and so on.

As only one example of a token 110, a credit card can be used with a conventional magnetic stripe included on one side thereof. Conventional magnetic stripes can include three tracks of data. Further to this example, the ISO/IEC standard 7811, which is used by banks, specifies: that track one is 210 bits per inch (bpi), and holds 79 six-bit plus parity bit read-only characters; track two is 75 bpi, and holds 40 four-bit plus parity bit characters; and track three is 210 bpi, and holds 107 four-bit plus parity bit characters. Most conventional credit cards use tracks one and two for financial transactions. Track three is a read/write track (that includes an encrypted PIN, country code, currency units, amount authorized), but its usage is not standardized among banks.

In a conventional credit card token, the information on track one is contained in two formats. Format A, is reserved for proprietary use of the card issuer. Format B, which includes the following:
a Start sentinel—1 character
Format code=“B”—1 character (alpha only)
Primary account number—up to 19 characters
Separator—1 character
Country code—3 characters
Name—2-26 characters
Separator—1 character
Expiration date or separator—4 characters or 1 character
Discretionary data—enough characters to fill out maximum record length (79 characters total)
End sentinel—1 character
Longitudinal Redundancy Check (LRC), a form of computed check character—1 character

The format for track two can be implemented as follows:
a Start sentinel—1 character
Primary account number—up to 19 characters
Separator—1 character
Country code—3 characters
Expiration date or separator—4 characters or 1 character
Discretionary data—enough characters to fill out maximum record length (40 characters total)
LRC—1 character

A credit card with magnetic stripe data is only one example of a token that can be used in this and other environments. As noted above, other tokens can include, for example, charge cards, debit and cards loyalty cards. This example environment is often described herein in terms of a debit card implementation for clarity and for ease of discussion. Upon entering into a debit transaction, a merchant may ask the customer to present his or her form of payment, which in this example is the debit card. The customer presents the token 101 (e.g., debit card) to the merchant for use in the transaction terminal 104. In one embodiment, the debit card can be swiped by a magnetic stripe reader or otherwise placed to be read by the data capture device 103. In the current example where a debit card utilizing a magnetic stripe is the token 101, data capture device 103 can include any of a variety of forms of magnetic stripe readers (such as, for example, a magnetic read head) to extract the data from the credit card. In other embodiments or implementations, other forms of data capture devices 103, or readers, can be used to obtain the information from token 101. For example, bar code scanners, smart card readers, RFID readers, near-field devices, and other mechanisms can be used to obtain some or all of the data associated with token 101 and used for the transaction.

The data capture device is in communicative contact with a terminal 104, which can include any of a number of terminals including, for example, a point of sale terminal, point of access terminal, an authorization station, automated teller machine, computer terminal, personal computer, work stations, cell phone, PDA, handheld computing device and other data entry devices. Although in many applications the data capture device 103 is physically separated, but in communicative contact with, the terminal 104, in other environments these items can be in the same housing or in integrated housings. For example, terminals such as those available from companies such as Ingenico, Verifone, Apriva, Linkpoint, Hypercom and others. For debit cards, terminal 104 can, for example, include a magnetic stripe reader and a keypad for entry of authentication data. Authentication data can include, for example, a PIN, password or other data used to authenticate a user or the token.

Continuing with the debit card example, the customer or cashier can swipe the customer's debit card using the card-swipe device, which reads the card data and forwards it to the cashier's cash register or other terminal 104. In one embodiment, the magnetic stripe reader or other data capture device 103 is physically separated, but in communicative contact with, the terminal 104. In other environments these items can be in the same housing or in integrated housings. For example, in current implementations in retail centers, a magnetic stripe reader may be placed on a counter in proximity to a customer, and electronically coupled to the cash register terminal. The cash register terminal may also have a magnetic stripe reader for the sales clerk's use.

The customer may be asked to present a form of ID to verify his or her identity as imprinted on the token 101. For transactions such as debit card transactions, the user may be required to key in a PIN or other authentication data entry. Often, the PIN pad is in the terminal 104. Continuing with the current example, the terminal 104 can be configured to print out a receipt (or may display a signature page on a display screen) and the customer may be required to sign for his or her purchases, thus providing another level of authentication for the purchase. In some environments, terminal 104 can be configured to store a record of the transaction for recordkeeping and reporting purposes. Further, in some environments, a record of the transaction may be kept for later account settlement.

Typically, before the transaction is approved, terminal 104 seeks authorization from one or more entities in a transaction processing network 123. For example, the merchant may seek approval from the acquiring bank, the issuing bank, a clearing house, or other entity that may be used to approve such transactions. Thus, depending on the token type, institutions involved and other factors, the transaction processing network 123 can be a single entity or institution, or it can be a plurality of entities or institutions. As a further example, in one embodiment, transaction processing network may include one or more processors or clearing houses to clear transactions on behalf of issuing banks and acquiring banks. The transaction processing network also include those issuing banks and acquiring banks. For example, one or more entities such as Global Payments, Visa, American Express, and so on, might be a part of transaction processing network. Each of these entities may have one or more processing servers to handle transactions.

In some instances, the approval may also constitute the final settlement of the transaction resulting in the appropriate funds being transferred to consummate the transaction. In other embodiments, however, the authorization may simply be an authorization only and actual account settlement can take place in a subsequent transaction. For example, authorization may verify the validity of certain information such as the account number, expiration date, customer name, and credit limit to determine whether to approve the transaction. Settlement may be accomplished when a series of one or more approved transactions are sent to the appropriate institution(s) for transfer of the funds or other account settlement.

As illustrated in FIG. 1, a gateway 120 can be included to facilitate routing of transactions, authorizations and settlements to and from the appropriate entity or entities within the transaction processing network 123. For example, where a merchant accepts credit cards from numerous different institutions, the gateway can use the BIN (Bank Identification Number) obtained from token 101 and passed to gateway 120 to route the transaction to the institution(s) associated with the given BIN. As illustrated by flow arrow 121, not all transactions are necessarily routed through a gateway 120. Transactions may take other paths to the appropriate entity or entities in the transaction processing network 123. Additionally, the term gateway as used herein is not restricted to conventional gateway applications, but is broad enough to encompass any server or computing system configured to perform any or all of the described functionality. The term gateway is used for convenience only.

Although transaction processing network 123 is illustrated using only one block in the example block diagram environment of FIG. 1, this block can represent a single entity to which the transaction is routed for authorization or settlement, or a network of entities that may be involved with authorization and settlement. Communications among the various components in the example environment can be wired or wireless transmissions using a variety of communication technologies formats and protocols as may be deemed appropriate for the given environment. As one example, the currently available credit card processing network and protocol structure can be utilized as the environment with which embodiments of the invention can be implemented. In fact, in one embodiment of the invention, various features and functions of the invention can be implemented within current or legacy transaction processing networks to provide enhanced features while reducing the level of change or upgrade required to the networking infrastructure.

From time-to-time, the present invention is described herein in terms of these example environments. Description in terms of these environments is provided to allow the various features and embodiments of the invention to be portrayed in the context of an exemplary application. After reading this description, it will become apparent to one of ordinary skill in the art how the invention can be implemented in different and alternative environments.

The present invention is directed toward a system and method for securing data in financial transactions. In one embodiment, the present invention is directed toward a system and method for securing account information as well as PIN information for token transactions.

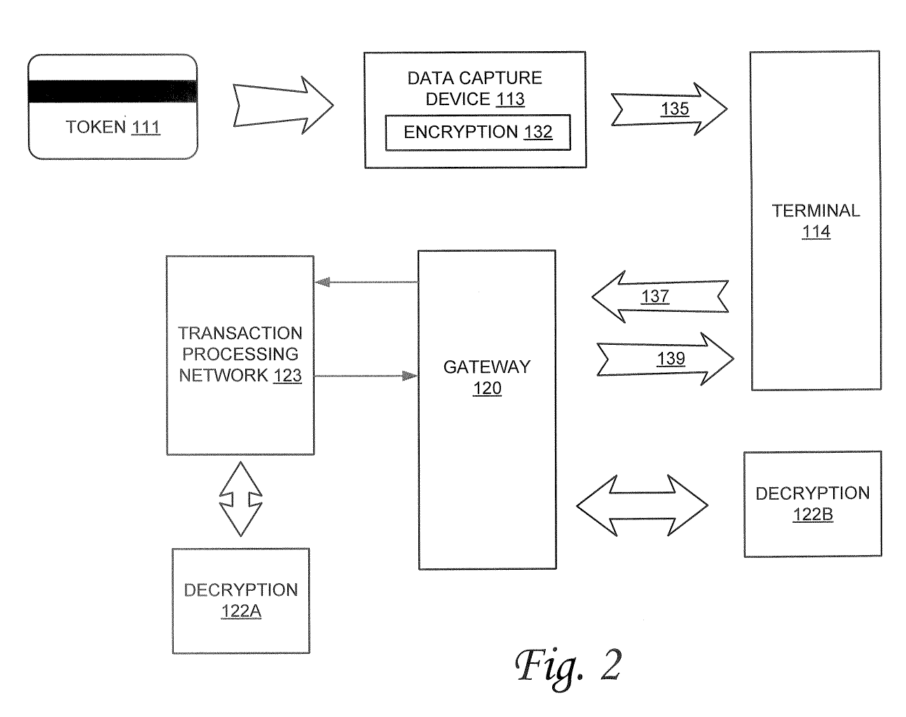

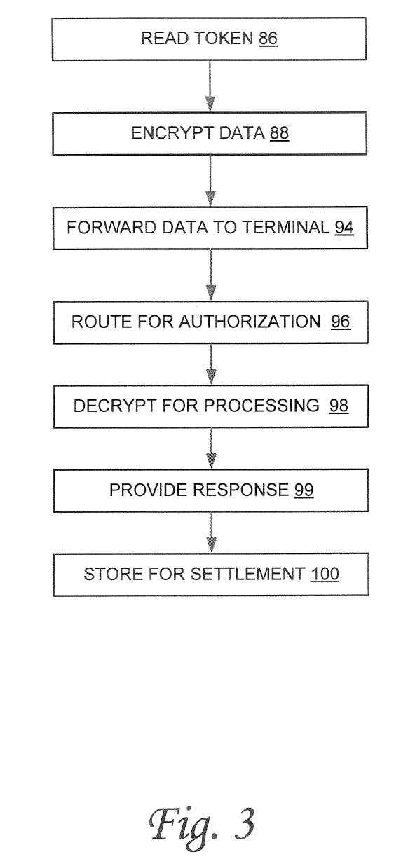

FIGS. 2 and 3 are diagrams illustrating an example implementation of features and functionality associated with embodiments of the invention in terms of the example environment. For illustrative purposes, focus is placed on the application of debit cards and PIN encrypting devices. However, after reading this description one of ordinary skill in the art will understand how to implement features and functions of the invention in other applications. FIG. 2 is a diagram illustrating an implementation of features that can be associated with the invention in accordance with one embodiment of the invention. FIG. 3 is an operational flow diagram illustrating a process for enabling secure token transactions in accordance with one embodiment of the invention. Referring now to FIGS. 2 and 3, in a Step 86, data from a token 111 is read by a data capture device 113. As discussed above, a token 111 can take on any of the number of different forms, including the examples discussed above with reference to a token 101 in FIG. 1. However, for ease of discussion, token 111 is referred to herein as a debit card.

Additionally, in one embodiment, the data encoded in token 111 can be encrypted during the fabrication or creation of token 111 or in the writing of the data onto token 111. Although token data can be referred to as being “on” for “in” a token, or encoded “onto” or “into” a token, such as token 111, these terms are not meant to imply or require a particular physical structure for encoding the token with data.

In a Step 88, an encryption module 132, which can include one or more encryption algorithms, is used to encrypt some or all of the token data. Although the encryption in accordance with the invention can take place at a number of different points along the data stream, it is preferable for security purposes that the encryption take place as soon as possible or practical in the data read cycle. Therefore, in one embodiment of the invention, the encryption module is in the data path immediately following the data capture. Preferably, then, the data can be encrypted as soon as it is read to enhance the security of the system.

To further enhance security, and provide safeguards against copying, skimming or other tampering, encryption module 132 can be encased in the same housing as the data capture assembly. Further, they can be encased in epoxy and steel, or other tamper-safe components to provide safeguards against tampering. Thus, in one embodiment, the entire data capture device can be encapsulated in a tamper-resistant package. As a particular example of this, consider an example application of the invention to facilitate secure credit card transactions. In this example application, a data capture device 113 can be implemented as a magnetic stripe reader with magnetic read or read/write heads used to extract data from the token 111. In this embodiment, encryption module 132 can be encapsulated with the magnetic heads using epoxy or other potting or sealing materials as well as steel or strong casing materials to provide safeguards against tampering with the unit. For example, the encryption module 132 and the read heads can be encapsulated in such a way that it would be difficult or impossible for a would-be tamperer to disassemble the unit to tap into the clear text data stream, or to reverse engineer the encryption algorithms, or to steal the encryption keys, without damaging the unit or leaving signs of tampering. As a further example, encryption module 132 can be implemented on a single substrate or in a single chip and packaged with the read head. Additionally, data detection circuitry and amplifiers (or other data read electronics) can likewise be included in the same chip package. The encryption module can be further implemented such that it does not store or transmit clear text account information to further help secure the information.

In another embodiment, pins or other contacts can be provided at predetermined locations in the package. The epoxy, resin, or other potting material can be a conductive material, thus creating a current path between and among the pins. Control logic in the head (for example, the processor) can measure the resistance across various paths between various pairs of pins. Thus, if an attempt is made to open the device or to probe the circuitry to obtain keys, algorithms or other encryption information, the resistance between one or more pairs of contacts will be changed. As such, intrusion can be detected. In one embodiment, the resistance values are used as a key by the processor to generate the encryption keys or other information. Thus, if the potting material is tampered with, the resistance changes, which changes the key, which affects the keys that the processor ultimately generates. As such, the encryption module will no longer generate valid encrypted data. Additionally, because the encryption keys are generated by the control logic using the key based on the resistance values, the encryption keys themselves are not available until generated. In use, they can be generated in realtime such that valid keys are not stored in the head. Not storing the keys adds a further measure of security. Various alternative contact configurations can be provided. For example, varying length pins can be provided around the periphery of the circuit board that houses the control logic. In one embodiment, pins ranging from approximately ½ mm to 1 mm are provided in an array or about the periphery and in contact with the potting material. In one embodiment, A/D ports of a processor can be used to measure the resistance values for the processor. In another embodiment, the contacts can extend into the head side as well. In such an application, if one were to attempt to cut the head to retrieve the keys, the pins would be cut, altering the resistance of the path between them.

In one embodiment, the potting material is created or used in a way that is non uniform, or otherwise not easily reproduced. Thus, for example, if the material characteristics vary in the manufacturing process or from application to application, the material cannot be easily removed and replaced while retaining functionality to create the correct keys. For example, amorphous or inhomogeneous materials can be used such that the conductive properties of the material may vary across its volume, or from application to application, thereby making the material difficult to remove and replace with the same characteristics. As another example, conductive screens or patterns can be used and embedded in the material to provide unique properties. For example, carbon fiber screens, mylar templates with conductive traces, nanotubes and other conductive elements and patterns can be used.

As such, these packaging and encapsulation techniques can be used to safeguard the integrity of the data stream and the encryption algorithms and keys. Additionally, in this example credit card application and other applications, the head or other data read assembly is typically fabricated with a certain degree of precision to enable accurate read and write operations. As such, removing or tampering with an appropriately packaged device could present difficulties for the would-be tamperer to reassemble the device with the level of accuracy and precision necessary to gain the appropriate read/write capabilities. As such, this example illustrates how encryption module 132 can be integrated with, encapsulated with or otherwise implemented with data capture device 113 to provide certain measures of security against tampering.

As stated above, encryption module 132 can be implemented so as to encrypt some or all of the data associated with token 111. Thus, the data output by the data capture device with the encryption module enabled can include an entire encrypted data stream, or a data stream having a combination of encrypted data and clear text data. In other words, in one embodiment, encryption module can be implemented to selectively encrypt only certain data items of the token data. Additionally, in one embodiment the invention can be implemented so as to disable encryption module 132 or otherwise bypass encryption module 132 to provide clear text data streams as may be necessary or desirable for a given application. Examples of selective encryption are further described

In a step 94, the data captured by data capture device 113, and encrypted with encryption module 132, is forwarded to terminal 114 in furtherance of the transaction. In an application in accordance with the example environment, terminal 114 can include a cash register or other point of sale station or terminal, as an example. In other environments terminal 114 can be implemented as appropriate including, for example, checkpoint terminals, customs station terminals, point of access terminals, point of sale terminals, or other terminal appropriate for the given application. One example of data capture and encryption is described in co-pending patent application Ser. No. 11/550,387, to von Mueller, et al., which is incorporated by reference herein in its entirety.

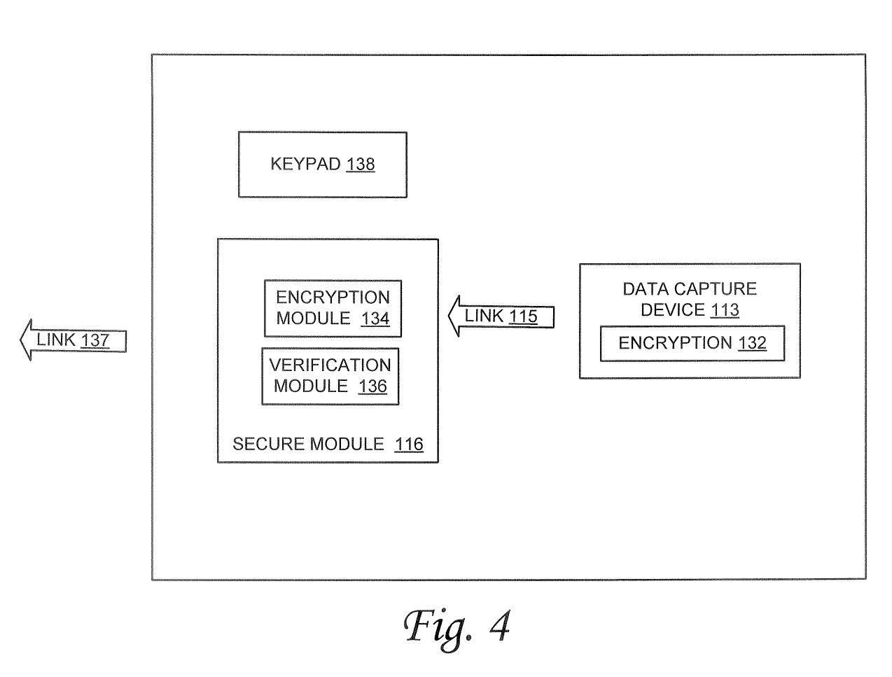

In the application of a point of sale terminal, the terminal 114 can, in one embodiment, be a card swipe terminal such as, for example, those portable or countertop terminals provided by VERIFONE, INGENICO and others. Other point of sale terminals might include, for example, gas pumps, ATM machines, vending machines, remote pay terminals, and so on. As another example, a terminal might include a token reader in communicative contact with a personal computer or other computing device for purchases such as, for example, internet purchases or for online banking. As a further example, in one embodiment, the terminal can include a magnetic stripe reader (including one or more read heads), a keypad (for example, for PIN entry, or other user entry), and a display. Thus, in this embodiment, the terminal 114 is integrated into the same package or housing as the data capture device 113. The terminal can also be integrated with or in communicative contact with a cash register or other point-of-sale or point-of-access station. One example of a terminal 114 and data capture device 113 implemented as a PIN encryption device (sometimes referred to as a PED), in accordance with one embodiment of the invention, is illustrated in FIG. 4.

In one embodiment, the data forwarded to terminal 114 is preferably packaged in a manner as may be expected by terminal 114. Thus, any of a number of packaging formats can be adopted for this and other communication channels in the transaction chain. However, in one embodiment, data capture device 113 can be implemented so as to package or format the data in a way that would be compatible with terminals 114 that may have been in use with previously-existing data capture devices that did not include encryption capabilities. As a specific example of this consider again the example application of a credit card or debit card transaction. In this example environment, a large number of magnetic stripe readers are currently in existence that provide clear text token data to existing terminals in a particular format that is expected by the terminal. Therefore, the data capture device can be configured to encrypt the data, place the encrypted string into the original location of the clear data that it replaces, recompute the checksum, include any sentinels or LRC and forward to the terminal. The terminal can then handle the transaction as a conventional transaction (for example, unencrypted transaction). In one embodiment, the terminal can check the check data (for example, with parity, LRC and a mod 10 check), which should be correct as it was regenerated by the encryption module using the inserted encrypted string. If the token fails, a bad read status can be output.

Thus, simply providing data encryption at the data capture device (e.g. at the magnetic stripe reader) could result in data incompatibility with the terminal, and with the rest of the network in some applications. As such, this embodiment packages the encrypted portions of the data with the clear text portions of the data in the same package format as the data would otherwise be presented to the terminal 114. As such, transactions (debit card transactions in this example) can be carried out in their usual fashion, without requiring terminal upgrades. Further examples of providing data encryption while retaining compatibility with conventional terminals is described more fully in co-pending patent application Ser. No. 11/550,387, to von Mueller, et al., which is incorporated by reference herein in its entirety.

Illustrated in FIG. 2, is a secure data stream 135 in which some or all of the data has been encrypted by encryption module 132 before transmission to terminal 114. In a step 94, secure data stream 135 is forwarded to terminal 114 in furtherance of the transaction. As such, terminal 114 can use or forward some or all of the elements of data stream 135 as appropriate in conducting the transaction. Continuing with the example of a debit card sale, terminal 114, such as a point of sale terminal or a card-swipe terminal, can use this transaction data to obtain authorization for the transaction, obtain user input (for example, press “Yes” to approve the sale, or entry of PIN) as well as to print the receipts (or communicate with a cash register or other device to print receipts) or otherwise consummate the transaction.

In a step 96, terminal 114 routes the data to the transaction processing network 123 to obtain authorization or approval for the transaction from one or more entities as appropriate. The transaction data stream 137 routed by terminal 114 can include some or all of the data provided in the secure data stream 135, and can be augmented to provide additional data as may be appropriate for the environment or type of transaction. In one embodiment, transaction data stream 137 is the same data and in the same format as secure data stream 135. In one embodiment, transaction data stream 137 can be formatted by terminal 114 in formats compatible with existing transaction processing equipment or in other formats as may be desirable or appropriate for a given application or network. For example, in one embodiment, a secure data stream 135 can be packaged in conformance with conventional terminal standards and sent to a conventional terminal 114, and processed and output by terminal 114 in accordance with its conventional standards. As another example, data stream 135 can be received by terminal 114 and terminal 114 can be configured to provide the packaging and signal conditioning for compatibility with downstream equipment. In yet another embodiment, to function with legacy transaction processing equipment, a replacement terminal with a compatible data capture device 113 (integrated or otherwise) can be provided to be plug-and-play compatible with the transaction processing network.

In some environments, the links between terminal 114 and the transaction processor(s) are relatively secure. As such, in one embodiment, terminal 114 can decrypt the data prior to transmission for transaction processing. Although not illustrated, terminal 114 can thus include decryption algorithms and keys used to decrypt the data prior to transmission. The decrypted data can be kept or formatted into in the same format as expected by the transaction processor. Additionally, terminal 114 can include an encryption module to encrypt some or all of the data output by terminal 114. Thus the data can be encrypted or reencrypted at the terminal prior to transmission. In one embodiment, the terminal processor, ASIC or other control logic used to decrypt or encrypt the data, and the associated keys, can be packaged in a secure manner such that if it is tampered with, the keys or other encryption information are automatically erased or otherwise destroyed. In another embodiment, the data capture device along with terminal components can be likewise packaged in a secure manner.

Illustrated in the example provided in FIG. 2 is a gateway 120 that also can be used to route the data stream. As discussed above with reference to FIG. 1, a gateway 120 may or may not be involved in the transaction routing depending on the application or transaction and the network configuration and participants, and other parameters such as, for example, the complexity of the network and the routing options available. For example, where multiple terminals 114 can be used to carry out transactions for credit cards from a plurality of issuing authorities, a gateway functionality can be useful to route the transaction data among the terminals and the elements of the transaction processing network.

As also discussed above with reference to FIG. 1, as used herein, the term “gateway” is broadly used to describe an entity, such as a server or other processing system, in the transaction stream that can be included to perform functions such as, for example, routing, interfacing, format or protocol conversion, storage, buffering and so on. For example, in one embodiment a gateway can be equipped for interfacing various terminals 114 with transaction processing network 123 or with various entities in transaction processing network 123. Further, in one embodiment, a gateway can be included to provide interfaces among various entities involved in the transaction. In terms of the example environment, a gateway may provide a common interface between a plurality of merchants and their terminals 114 on the one hand, and various banks, institutions or other entities on the other hand. Functionality that might be included in a gateway 120 can be, for example, protocol translation, data formatting, impedance matching, rate conversion, fault isolation, signal translation, buffering and storage, routing, or other functions as necessary or useful to provide interoperability or communications among transaction participants.

Gateways can be implemented using hardware software or a combination thereof. In one embodiment, gateway 120 is implemented as one or more processing devices configured to run software applications for the gateway functionality. In one or more embodiments discussed in this document, functions such as encryption, decryption, key storage and other related functions are at times discussed as being performed at or by a gateway. This description encompasses implementations where functions are performed using a separate module or appliance called by or otherwise accessed by the gateway. For example, in one or more embodiments, these functions are described as being performed by a secure transaction module that can be either a part of the gateway or accessed by the gateway. As will be apparent to one of ordinary skill in the art after reading this description, such discussion can indicate that the same devices that perform gateway functionality can also include hardware or software modules used to perform these encryption, decryption or other functions as well.

Alternatively, separate modules can be in communicative contact with the gateways and their functions called, accessed or used by the gateway to perform the encryption, decryption or other related functions. Indeed, in one embodiment, one or more separate appliances are provided to perform various decryption, encryption, key storage and updating and other functions, and the appropriate transaction data routed to the appropriate appliance for processing. Such appliances can themselves be implemented using hardware software or a combination thereof, and can be coupled in communicative contact with the gateway. As discussed herein, such appliances (sometimes also referred to as secure transaction modules) can be associated with entities other than the gateway, including issuing banks, acquiring banks, clearing houses, merchants and other entities that may be associated with, the transaction processing network 123.

In a step 98, the encrypted information is decrypted for processing of the transaction. In the example illustrated in FIG. 2, the transaction data stream or other appropriate transaction data is routed to the transaction processing network 123 entity or entities that will perform the authorization or other approval. In this example illustrated, the decryption occurs in this network or at this institution such that the clear text information can be recovered to facilitate transaction processing. The invention can be implemented so as to provide the decryption functions at any point in the transaction process as may be appropriate or desired for given security purposes. For example, once the transaction data reaches a secure processing network, it may be appropriate to decrypt the data within that network and handle the data as clear text because the network is secure. As another example, once the transaction reaches a clearing house, a secure transaction module can decrypt the information at or for the clearing house, and the transaction forwarded to the issuing bank for consummation. As yet another example, the transaction can remain encrypted until it reaches the issuing bank and can be decrypted at the issuing bank for processing. Where information is decrypted for handling or other processing (or for other purposes) prior to reaching its final destination, that information can be re-encrypted for subsequent transmissions.

As another example, connections between the gateway 120 and the transaction processing network 123 may themselves be secure connections. In such situations, it may be desirable to decrypt some or all of the transaction data stream at gateway 120 prior to routing to the transaction processing network 123. In furtherance of this example, consider a token transaction in which the entire account information is encrypted. It may be desirable in such a situation to have the gateway decrypt the account information to obtain the bank identification number to facilitate routing. With a secure connection, the decrypted information can be left in the clear for transfer to the transaction processing network 123. In another embodiment, the gateway can be configured to re-encrypt some or all of the decrypted information prior to routing.

As another example, even where the routing data is clear, it may be desirable to have a secure transaction module available at the gateway to decrypt the transactions routed by that gateway. As such, a centralized (or somewhat centralized in the case of multiple gateways) decryption process can be implemented to handle decryption in one location (or in predetermined locations) for multiple transactions for multiple merchants and multiple issuers. In such an application, centralized decryption can be implemented to provide centralized key management or centralized of other encryption algorithms or information.

Thus, to illustrate two of the possible decryption-placement scenarios, a decryption module is illustrated as decryption module 122A associated with transaction processing network 123 and a decryption module 122B associated gateway 120. As these examples serve to illustrate, decryption of some or all of the information can be performed at one or more points along the network as may be appropriate for a given transaction. As also discussed in further detail below, various levels of encryption and decryption using one or more keys for portions of the data can be included to facilitate routing and handling of transactions in a secure manner.

For example, the gateway can be configured to decrypt the transaction data stream, determine the routing or other gateway-specific information (for example reading the bank identification number for routing), and re-encrypt the data before forwarding it along to the transaction processing network 123. Additionally, in another embodiment as discussed above where the bank identification number, or a portion thereof, may be left in clear text, the gateway or other network components can be implemented to route the transaction based on the clear text bank identification number such that interim decryption and re-encryption is not used to determine this routing.

In another embodiment, where the secure transaction module is configured to decrypt account information, the secure transaction module can be configured so as to not store clear text account information for security purposes. Thus, in this embodiment, the appliance can be configured to receive encrypted information, perform a decryption and forward the clear text information without storing a local copy of clear text information. In one embodiment, however, hashes of the account information or other token data can be maintained at the secure transaction module to enable the module to check for duplicate transactions. In another embodiment, the secure transaction module can be configured to provide data for reporting or record keeping purposes. For example, the secure transaction module can provide hashes, transaction amounts, merchant IDs, terminal IDs, transaction dates, etc. for reporting transaction information or other data.

Additional example details regarding decryption and routing that can be used with the present invention are further described in co-pending patent application Ser. No. 11/550,387, to von Mueller, et al., which is incorporated by reference herein in its entirety.

In a step 99, an authorization response is provided from the transaction processing network 123 indicating the status of the authorization. For example, where the transaction is approved, such authorization is transmitted to terminal 114 and can be stored at the terminal or in a storage device associated with the terminal for record-keeping purposes or further transactions. For example, considering again the application in a credit card transaction, when the initial transaction is carried out, terminal 114 typically seeks authorization from the transaction processing network 123 and, once authorized, stores transaction information in a data file or other database for later settlement of the transaction. Thus, in this example, terminal 114 could store information associated with the authorized transaction for later settlement as illustrated by step 100.

In one embodiment, an administrative toolkit can be provided for remote management of terminals and services. A variety of access mechanisms can be provided including, for example, an XML API that provides an interface for entities to extract critical reporting information from the secure transaction module and key management module, as well as providing the ability to remotely manage terminal statuses with or without the use of command cards. The reporting data available through the API can include information such as: vital statistics for the terminals, the security integrity of the terminals, the number of swipes per terminal, the number of rejected credit cards, and various other key metrics.

FIG. 4 is a functional block diagram illustrating an example PIN encryption device terminal in accordance with one embodiment of the invention. Referring now to FIG. 4, in the illustrated exemplary embodiment, the PIN encrypting device includes a data capture device 113, a communication link 115, a secure module 116, and a key pad 138. Although not illustrated, the PIN encrypting device can also include other features and functions such as, for example, a display to display characters or other information to a user, a communication interface to interface the PIN encryption device with other devices such as for example, cash registers, point of sale devices, pay transaction processing network 123 or other external devices. The communications link 115 could be a wired or wireless link, and any communication medium can be used that is suitable for carrying the token data.

As also illustrated in the example embodiment of FIG. 4, data capture device 113 includes an encryption module 132 to encrypt the data that is read from the token as well as an encryption module 134 within secure module 116 to encrypt PIN or other information that may be entered by the user in key pad 138.

In the example of debit cards or other like tokens, these tokens can include a magnetic stripe on which the data is maintained. Thus, in one embodiment, data capture device 113 can include one or more magnetic heads to read data from one or more tracks on the magnetic stripe. Further, in such embodiments, data capture device 113 and encryption module 132 can be encapsulated into an encrypting head in a manner so as to inhibit tampering with the encryption mechanism within the read heads. Examples of encapsulating an encryption module with a magnetic read head are described in copending patent application US 2006/0049255 to Mos, et al, as well as in co-pending patent application Ser. No. 11/550,387, to von Mueller, et al., each of which are incorporated by reference herein in their entirety.

In one embodiment, the read heads can be dual-gap heads or other multiple-gap read heads to allow jitter data to be read from the magnetic stripe to enable authentication of the medium. The multi-gap heads can also be used, as described herein, to verify the integrity of communication link 115. Examples of dual-gap read heads that can be used to verify the communication link 115 are described in U.S. Pat. No. 5,770,846, to Mos, et al., and U.S. Pat. No. 6,830,183 to Mos, et al., each of which are incorporated herein in their entirety. Although the Mos '846 and '183 patents illustrate examples of multiple-gap read heads, other multi-gap structures can be used as well. Additionally, one of ordinary skill in the art would appreciate after reading this description that alternative read structures can be used to provide spatially diverse detection of token data. For example, magneto-resistive read heads having a single or multi-dimensional array of read structures can also be used.

As illustrated in FIG. 4, secure module 116 includes an encryption module 134 to encrypt information entered at key pad 132. Although illustrated as within secure module 116, encryption module could alternatively be provided without a secure module 116 or external to secure module 116. However, secure module 116 can be used to provide a measure of security to encryption module 134. In one embodiment, secure module 116 can be implemented as a hardware security module (sometimes referred to as an HSM) to provide a measure of security for encryption keys and algorithms. For example, in one embodiment, secure module 116 can be implemented in accordance with specifications set forth by InfoGard Laboratories, Inc. at 641 Higuera Street, San Luis Obispo, Calif. 93401, to provide a measure of security against tampering with encryption keys, encryption algorithms or other data or information contained within secure module 116. In other embodiments, other security modules and security techniques can be implemented as well.

The encrypted token data and the encrypted PIN or other information can be packaged into secure transaction data 137 for transmission to transaction processing network 123 (whether or not via a gateway 120). Such packaging can be done within or outside of secure module 116. Other transaction data can be combined with the token data and PIN including, for example, merchant IDs or other information, Terminal IDs, transaction amount, and so on. An application running on a processing device or other control logic can be used to accomplish the data packaging.

Depending on the implementation, the PIN encryption device can be implemented to provide a measure of security against magnetic stripe data as well as PIN data without increasing the parameter of security module 116. For example, as the embodiment illustrated in FIG. 4 depicts, some or all of the account or other sensitive information captured from the token 111 is encrypted at data capture device 113, preferably within an encapsulated encryption module 132. As such, the data sent from data capture device 113 to secure module 116 is encrypted and somewhat protected from tampering. Therefore, token data can be secured without expanding the parameter of secure module 116. However, in one embodiment, the parameter of the secure module 116 can be expanded to include data capture device 113 and conceivably most if not all of the entire PIN encryption device terminal. However, because of the cost associated with a larger parameter on secure module, other alternative may be desirable to deter tampering with data capture device 113 and communication link 115. Therefore, in one embodiment, the integrity of communication link 115 can be determined to provide an added measure of security. Before describing techniques for verifying the integrity of the communication link, a vulnerability of the system without a verified communication link is first described.

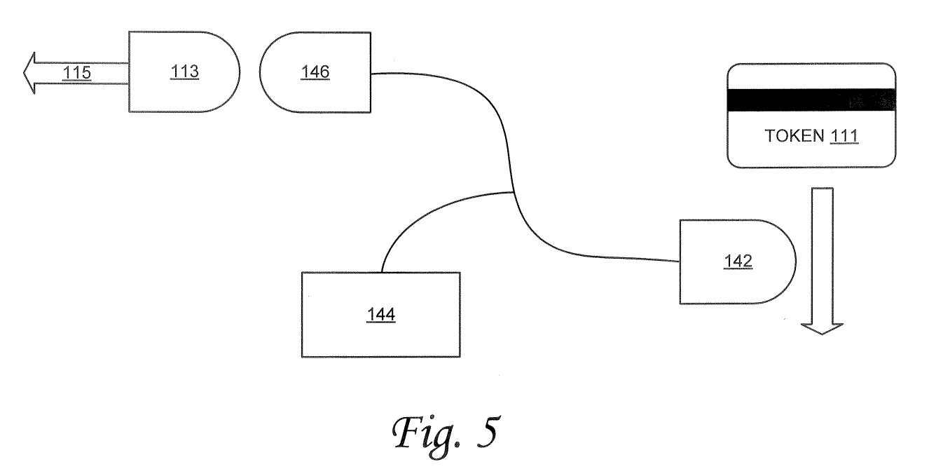

FIG. 5 is a diagram illustrating an example vulnerability of communication link 115. Particularly, FIG. 5 illustrates a scenario whereby a would-be tamperer might attempt to obtain data from token 111 before it is encrypted by data capture device 113. Referring now to FIG. 5, in this example, a would-be tamperer has placed a standard non-encrypting read head 142 at the magnetic stripe reader. Magnetic read head 142 reads data from the magnetic stripe and, because it is not an encrypting head, clear text data can be tapped off from the read head 142 and recorded at a recording module 144 or otherwise skimmed. The clear text data can be further transmitted to another transducer 146 that is placed in proximity with data capture device 113. The theory being that data “written” by transducer 146 (for example, a write head) can be detected and read by data capture device 113, thereby fooling the system into thinking that data capture device 113 is reading the data directly from the magnetic stripe and that there is no skimming of the clear data. Thus, even with an encrypting head, where access to the PIN encryption device is possible, scenarios exist wherein clear token data might be skimmed.

In one embodiment, this scenario can be avoided by using a dual-gap or multi-gap read head for data capture device 113. To elaborate, in one embodiment, the gaps in the head can be appropriately spaced such that they each detect a given transition at a different time. Thus, one gap may be detecting one transition at approximately the same time the second gap is detecting a different transaction or a non-transition. In such embodiments, jitter detection logic, encryption logic or other logic can be configured to look at the data detected at each of the gaps and verify the integrity of the link. In a situation where a write head 146 is used to “transmit” data to a read head 113, closely spaced read gaps in read head 113 would each sense the same data at the same time. As such, the existence of a tap configuration such as that illustrated in FIG. 5 could be detected. Detection could be performed by the inclusion of control logic (hardware, software, or a combination thereof) to evaluate the data sensed by the plurality of gaps or other read structures in read head 113. Thus, an verification module 136 can be provided to evaluate this data, either within or outside of secure module 116.

In one embodiment, the authentication module can be configured to look for the presence or absence of different transitions sensed by each gap. For example, in one embodiment, where a plurality of gaps sense the same transitions at the same time, this could be an indication of compromised link integrity. In one embodiment, before a conclusion as to compromised integrity is reached, the verification module 136 can be configured to evaluate the data to determine whether the gaps sense the same transitions at the same time over a predetermined period of elapsed time.

In another embodiment, evaluation module 136 can be configured to determine whether the read structures (for example, the plurality of read gaps) are detecting token data with a spatial diversity that is in accordance with the spacing or other geometry associated with the read structures. For example, with a given gap spacing, transitions sensed by a first gap would be expected at the second gap at a subsequent time. With a proper allowance for occasional read errors, the same data sequence would be expected at both (or all) read gaps, but shifted in time from one gap to the next. Thus, detecting a data stream at one gap and a time-delayed version of the same data stream at a second gap can authenticate the integrity of the link. Alternatively, evaluating the time between detected transitions at the various read structures in accordance with known spacing or other geometry of those structures can also be used to determine whether the link has been compromised. For example, distances between transitions sensed by the gaps can be evaluated against known distances between the gaps and expected transition spacing on the medium.

In another embodiment, the inability of the system to authenticate the token as described in the Mos' 846 patent, for example, would lead to a read failure likewise defeating the tap. As these examples illustrate, other techniques can be used to assure that appropriate data from the plurality of gaps on the read head (or other read structures) is appropriately detected.

Where a link is detected as potentially compromised, the terminal can be configured to respond in a variety of ways. For example, the terminal might be configured to cease operating and conducting transactions. In another embodiment, secure module safeguards might be activated to destroy the keys or other encryption data. In yet another embodiment, an alert might be generated to inform appropriate entities that the device has been compromised. For example, a message could be displayed on a display screen of the terminal, alerting the merchant (as well as subsequent users) that the terminal is potentially insecure. Alerts could also be sent with transaction data (or in another message) to the gateway or the transaction processing entities such that appropriate action can be taken. In yet another embodiment, subsequent emails or other alerts can be sent to the actual card holder, informing him or her that his or her card might be compromised.

As used herein, the term module is used to describe a given unit of functionality that can be performed in accordance with one or more embodiments of the present invention. As used herein, a module can be implemented utilizing any form of hardware, software, or a combination thereof. In implementation, the various modules described herein can be implemented as discrete modules or the functions and features described can be shared in part or in total among one or more modules. In other words, as would be apparent to one of ordinary skill in the art after reading this description, the various features and functionality described herein may be implemented in any given application can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

The term tool can be used to refer to any apparatus configured to perform a recited function. Tools can include a collection of one or more modules and can also be comprised of hardware, software or a combination thereof. Thus, for example, a tool can be a collection of software modules, hardware modules, software/hardware modules or any combination or permutation thereof. As another example, a tool can be a computing device or other appliance on which software runs or in which hardware is implemented.

All patents, applications, published applications and other publications referred to herein are incorporated by reference in their entirety. If a definition set forth in this section is contrary to or otherwise inconsistent with a definition set forth in applications, published applications and other publications that are herein incorporated by reference, the definition set forth in this section prevails over the definition that is incorporated herein by reference.

While various embodiments of the present invention have been described above, it should be understood that they have been presented by way of example only, and not of limitation. Likewise, the various diagrams may depict an example architectural or other configuration for the invention, which is done to aid in understanding the features and functionality that can be included in the invention. The invention is not restricted to the illustrated example architectures or configurations, but the desired features can be implemented using a variety of alternative architectures and configurations. Indeed, it will be apparent to one of skill in the art how alternative functional, logical or physical partitioning and configurations can be implemented to implement the desired features of the present invention. Also, a multitude of different constituent module names other than those depicted herein can be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead can be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other software or hardware components, can be combined in a single package or separately maintained and can further be distributed across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

1. A method for securing transaction data, comprising:
reading token data from a token using a read apparatus and encrypting the token data at the read apparatus;
sending the encrypted token data to a security module over a communication link; and
verifying the integrity of the communication link based on encrypted token data.

2. The method of claim 1, further comprising the steps of:
receiving authentication data for the token and encrypting the authentication data within the security module; and
combining the encrypted token data and encrypted authentication data into a transaction data stream.

3. The method of claim 1, wherein the step of reading token data comprises the step of detecting token data at a plurality of read structures, and the step of verifying the integrity of the communication link comprises determining whether the read structures are detecting token data with a spatially diversity in accordance with a geometry of the read structures.

4. The method of claim 1, wherein the step of reading token data comprises the step of detecting token data at a plurality of read structures, and the step of verifying the integrity of the communication link comprises detecting distances between transitions based on distances between the read structures.

5. The method of claim 1, wherein the step of reading token data comprises the step of detecting token data at a plurality of read structures, and the step of verifying the integrity of the communication link comprises determining whether the first gap detects data different from that detected by the second gap at a given read time.

6. The method of claim 1, wherein the step of reading token data comprises the step of detecting token data at a plurality of read structures, and the step of verifying the integrity of the communication link comprises determining whether, over a predetermined time period, the first and second gaps are sensing the same transitions at substantially the same time to verify the integrity of the link.

7. The method of claim 1, further comprising the step of generating an alert if the integrity of the link is determined to be compromised.

8. A transaction terminal, comprising:
a token data encryption module configured to encrypt data read from a token at the terminal;
a communication link coupled to the encryption module and a verification module coupled to the communication link and configured to verify the integrity of the communication link.

9. The transaction terminal of claim 8, further comprising
a user interface configured to accept authentication data for the token and an authentication data encryption module coupled to the interface; and
a data packaging module coupled to the authentication data encryption module and to the communication link and configured to package the encrypted authentication data and the encrypted token data into transaction data.

10. The transaction terminal of claim 8, further comprising a secure module enclosing the authentication encryption module.

11. The terminal of claim 8, wherein the data capture device is a multi-gap magnetic read head.

12. The terminal of claim 8, wherein the data capture device comprises multiple read structures.

13. The terminal of claim 12, wherein the verification module is further configured to determine whether the read structures are detecting token data with a spatially diversity in accordance with a geometry of the read structures.

14. The terminal of claim 12, wherein the verification module is further configured to detect distances between transitions based on distances between the read structures.

15. The terminal of claim 12, wherein the verification module is further configured to determine whether the first gap detects data different from that detected by the second gap at a given read time.

16. The terminal of claim 12, wherein the verification module is further configured to determine whether, over a predetermined time period, the first and second gaps sense the same transitions at substantially the same time to verify the integrity of the link.

17. A computer program product having a computer program embodied in a computer readable medium adapted to verify the integrity of token data read at a transaction terminal, the computer program comprising machine readable code adapted to cause a processing device to:
read token data from a token using a read apparatus and encrypting the token data at the read apparatus;
send the encrypted token data to a security module over a communication link; and
verify the integrity of the communication link based on encrypted token data.

18. The computer program product of claim 17, further comprising machine readable code adapted to cause a processing device to:
receive authentication data for the token and encrypting the authentication data within the security module; and
combine the encrypted token data and encrypted authentication data into a transaction data stream.

19. The computer program product of claim 17, wherein the machine readable code adapted to cause a processing device to read token data comprises machine readable code adapted to cause a processing device to detect token data at a plurality of read structures, and the machine readable code adapted to cause a processing device to verify the integrity of the communication link comprises machine readable code adapted to cause a processing device to determine whether the read structures are detecting token data with a spatially diversity in accordance with a geometry of the read structures.

20. The computer program product of claim 17, wherein the machine readable code adapted to cause a processing device to read token data comprises machine readable code adapted to cause a processing device to detect token data at a plurality of read structures, and the machine readable code adapted to cause a processing device to verify the integrity of the communication link comprises machine readable code adapted to cause a processing device to detect distances between transitions based on distances between the read structures.

21. The computer program product of claim 17, wherein the machine readable code adapted to cause a processing device to read token data comprises machine readable code adapted to cause a processing device to detect token data at a plurality of read structures, and the machine readable code adapted to cause a processing device to verify the integrity of the communication link comprises machine readable code adapted to cause a processing device to determine whether the first gap detects data different from that detected by the second gap at a given read time.

22. The computer program product of claim 17, wherein the machine readable code adapted to cause a processing device to read token data comprises machine readable code adapted to cause a processing device to detect token data at a plurality of read structures, and the machine readable code adapted to cause a processing device to verify the integrity of the communication link comprises machine readable code adapted to cause a processing device to determine whether, over a predetermined time period, the first and second gaps are sensing the same transitions at substantially the same time to verify the integrity of the link.

23. The computer program product of claim 17, wherein the machine readable code further comprises machine readable code adapted to cause a processing device to generate an alert if the integrity of the link is determined to be compromised.
